(19) United States
(12) Patent Application Publication
(10) Pub. No.: US 2003/0196381 A1
(43) Pub. Date: Oct. 23, 2003

(54) Evaporator device for generating a hydrocarbon-air mixture which can be decomposed in a reformer to produce hydrogen and process for operating such an evaporator device

(76) Inventor: Gunter Eberspach, Wolfschlugen (DE)

Correspondence Address: McGLEW AND TUTTLE, P.C., SCARBOROUGH STATION, SCARBOROUGH, NY, 10510-0827, US

(21) Appl. No.: 10/375,211

(22) Filed: Feb. 26, 2003

(30) Foreign Application Priority Data
Apr. 19, 2002 (DE) 102 17 675.2

(51) Int. Cl. C01B 3/24

(52) U.S. Cl. 48/197 FM; 48/211; 48/212; 48/214 R; 48/215; 48/214 A; 48/197 R; 48/180.1; 48/189.2; 48/61; 48/62 R; 48/75

(57) ABSTRACT

An evaporator device for generating a hydrocarbon-air mixture which can be decomposed in a reformer for producing hydrogen comprises a burner/evaporator area, which has a combustion/mixing chamber (14), into which air enters via an inlet opening device (16), a hydrocarbon evaporating means (24, 34), comprising a porous evaporator medium (24) and, associated with same, a first heating means (34) and a glow-type igniting member (28) for igniting the hydrocarbon-air mixture present in the combustion/mixing chamber (14).

### FIELD OF THE INVENTION

The present invention pertains to an evaporator device for generating a hydrocarbon-air mixture which can be decomposed in a reformer to produce hydrogen and to a process for operating such an evaporator device.

### BACKGROUND OF THE INVENTION

Reformers are used to split hydrocarbons or hydrocarbon-containing materials in a catalytic reaction and to release or produce hydrogen in the process. This hydrogen can be used, e.g., in fuel cells to generate electricity, or it can be used in an exhaust gas guiding system of an internal combustion engine to process the exhaust gas. To make it possible to react the mixture fed to a catalyst material in such reformers or to start and maintain the catalytic reaction, it is necessary to bring the area of the reformer, i.e., essentially the assembly units that come into contact with the mixture and the catalyst material as well as the mixture to a certain operating temperature. The temperature for producing hydrogen from a diesel fuel vapor-air mixture is in the range of 320° C. for starting the catalytic reaction. Once this reaction has been started, it can be continued at a temperature of about 240° C. However, this means that, especially in the case of use in motor vehicles, the relevant areas of the system must be heated up from comparatively low temperatures, which are in the range as low as −40° C., to these comparatively high operating temperatures as rapidly as possible. It is generally known that the essential system components are heated and the energy for evaporating the fuel or hydrocarbon, which is generally in the liquid form, is obtained by loading the onboard power supply system of vehicles. However, this represents a high load for the onboard power supply system, as a consequence of which the time elapsing until the necessary temperatures are reached may be very long because of the limited performance capacity.

### SUMMARY OF THE INVENTION

The object of the present invention is to provide an evaporator device for generating a hydrocarbon-air mixture which can be decomposed in a reformer to produce hydrogen as well as a process for starting up such an evaporator device, in which the time needed to reach the operating temperatures that are necessary especially in the area of a catalyst material is kept short in a highly efficient manner in terms of energy usage.

According to a first aspect of the present invention, this object is accomplished with an evaporator device for generating a hydrocarbon-air mixture which can be decomposed in a reformer to produce hydrogen, comprising a burner/evaporator area with a combustion/mixing chamber, in which air enters via an inlet opening device, a hydrocarbon evaporating means, comprising a porous evaporator medium and a first heating means associated with same, and a glow-type igniting member for igniting the hydrocarbon-air mixture present in the combustion/mixing chamber.

The essential feature of the present invention is that the thermal energy for reaching the operating temperatures especially also in the area of the catalyst material of the reformer is not provided by, e.g., heating devices that can be operated electrically, but the mixture proper that is to be decomposed to produce hydrogen is first burned in the evaporator device. High temperatures are generated during this combustion, so that the combustion waste gases, which also flow in the direction of the catalyst material and the system components of the reformer which are located there, contribute to the very rapid heating. It was found that heating from very low starting temperatures to the temperatures necessary for the operation in the range above 300° C. can be achieved with this device according to the present invention in less than 15 to 30 sec.

For example, provisions may be made in the device according to the present invention for the hydrocarbon evaporating means to be arranged at a bottom area of the combustion/mixing chamber. Furthermore, it is possible to arrange the inlet opening device in a wall area surrounding the combustion/mixing chamber. To start the combustion especially in the area in which a high concentration of combustible fuel, i.e., hydrocarbon, is present, it is proposed that the glow-type igniting member be elongated and that it extend at a spaced location from the hydrocarbon evaporating means approximately in parallel to same.

The first heating means may be preferably operated electrically.

According to another advantageous aspect, a second heating means may be provided for heating a wall surrounding the combustion/mixing chamber and/or a wall adjoining the combustion/mixing chamber in the direction of flow.

Since very high temperatures occur, e.g., in a fuel cell or also in an exhaust gas guiding system of an internal combustion engine in various areas, it is proposed according to another aspect of the present invention for the second heating means to comprise a heat exchanger device through which heated fluid can flow. The heated fluid in question may then be heated in the areas in which high temperatures occur, e.g., due to exothermal reactions.

According to another aspect of the present invention, the object mentioned in the introduction is accomplished by a process for starting up an evaporator device for generating a hydrocarbon-air mixture which can be decomposed in a reformer for producing hydrogen, comprising the steps:

a) heating and evaporation of liquid hydrocarbon or hydrocarbon-containing liquid,

b) mixing of the vapor generated in step a) with air,

c) ignition of the mixture generated in step b) for starting the combustion of the mixture,

d) maintenance of the combustion until a predetermined time period expires and/or until a predetermined temperature occurs in one or more predetermined areas of the system,

e) termination of the combustion after the expiration of the predetermined time period and/or after the predetermined temperature has been reached.

Consequently, an evaporator device is operated according to the present invention such that the mixture proper that is to be decomposed for producing hydrogen is burned first, and the combustion is then stopped when the system components operating for producing hydrogen, i.e., especially the system area of the reformer containing the catalyst, are in a state in which the catalytic reaction can take place. Following this, the mixture which continues to be produced will then be available for producing hydrogen.

For example, provisions may be made to activate a heating means that can be operated preferably electrically for the evaporation. This heating means is preferably activated at least during the steps c) and d).

To make it possible to terminate the combustion when the thermal state necessary for the catalytic reaction is reached, it is proposed that the supply of liquid hydrocarbon or the hydrocarbon-containing liquid be reduced or interrupted and/or that the supply of air be reduced or interrupted in step e). The catalytic reaction can be continued or started after the termination of the combustion by continuing or resuming the supply of liquid hydrocarbon or the hydrocarbon-containing liquid and the supply of air for generating the mixture which can be decomposed to generate hydrogen after the termination of the combustion in step e).

To load the onboard power supply system of a vehicle as little as possible during the catalytic reaction, it is proposed that the heating means not be activated when the combustion generation is no longer activated, during and/or after step e).

Furthermore, provisions may be made in the process according to the present invention for using fossil fuel, preferably diesel fuel or the like, as the liquid hydrocarbon or hydrocarbon-containing liquid.

Furthermore, the present invention pertains to a reformer for producing hydrogen from a hydrocarbon-air mixture, comprising an evaporator device according to the present invention.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a basic longitudinal sectional view of an evaporator device according to the present invention; and

FIG. 2 is a block diagram view of a reformer system in conjunction with an evaporator device according to the present invention.

### DESCRIPTION OF THE PREFERRED EMBODIMENTS

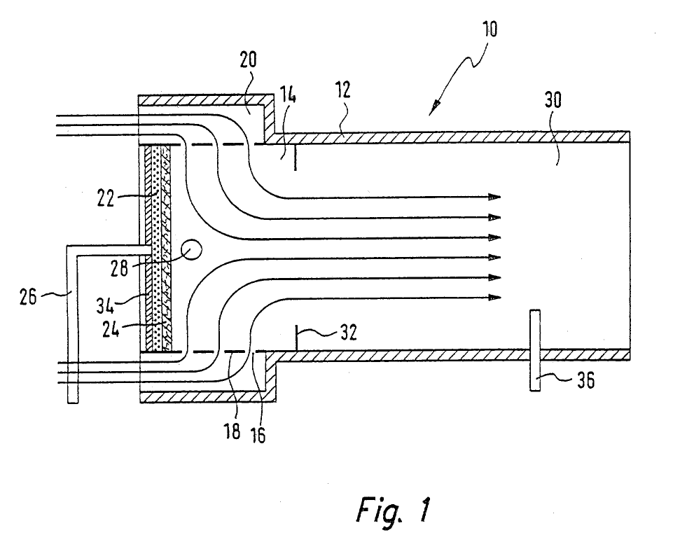

Referring to the drawings in particular, an evaporator device according to the present invention is generally designated by 10 in FIG. 1. The evaporator device 10 comprises an elongated, tubular housing arrangement 12, in which a mixture of evaporated fuel, e.g., diesel fuel, and air is formed, as will be described below. A combustion/mixing chamber 14 is provided for this purpose in the housing 12. The combustion/mixing chamber 14 is fed air from a radially outer ring-shaped space 20 via a plurality of inlet openings 16 in an outer circumferential wall 18. A porous evaporating medium 24, which may be formed, e.g., by nonwoven material or another fabric or mat-like material, foamed ceramic or the like, is provided at a bottom area 22 of the combustion/mixing chamber 14. A fuel feed line 26 passes through the bottom area 22 and introduces the fuel to be evaporated into the porous evaporator medium 24. An igniting member 28 of a plug-like design, e.g., a glow-type ignition plug, is located at an axially spaced location from the bottom area 22 or the evaporator medium 24 arranged thereon, axially in relation to an overall direction of flow within the tubular housing 12. This igniting member extends at right angles to the longitudinal or axial direction mentioned and is located essentially in parallel to the bottom area 22 or the side of the evaporator medium 24 facing the combustion/mixing chamber 14. The fuel-air mixture, which is formed in the combustion/mixing chamber 14 by the air supply, on the one hand, and by the evaporation of the fuel, on the other hand, and which can also be considered to be a hydrocarbon-air mixture, leaves the combustion/mixing chamber 14 and enters a volume area 30 in which the catalyst material of a reformer, not shown in the figure, may be arranged. The mixture leaving the combustion/mixing chamber through a diaphragm 32 and flowing toward the catalyst is split at the catalyst by catalytic reaction in order to produce hydrogen. This hydrogen may then be used further, e.g., in a fuel cell to generate electricity or in an exhaust gas guiding system of an internal combustion engine for exhaust gas cleaning.

To make it possible to carry out the catalytic reaction in such a reformer, it is necessary that not only the mixture, which shall be reacted in this catalytic reaction, but also the various system components, e.g., the catalyst material, the wall material surrounding same and the like, have a certain temperature. For example, it may be necessary in case of the use of a diesel fuel-air mixture to provide heating to about 320° C. in such an arrangement to start the catalytic reaction. Once this reaction has been started, it can then continue at a temperature of about 240° C. These high temperatures require the introduction of a comparatively large amount of energy, especially for starting the catalytic reaction, in order to bring about the necessary heating. It shall be pointed out that such systems are used, e.g., in vehicles, and they must also be able to be operated at outside temperatures in the range down to −40° C. Consequently, this means that heating of the various system components over a temperature range of nearly 400° C. must be brought about in a comparatively short time.

The manner in which this heating is accomplished in the evaporator device according to the present invention will be described below.

It is recognized in the figure that a heating means 34 is provided at the bottom area 22. This may be operated preferably electrically and comprises, e.g., a heating coil or the like, which is located on the side of the bottom area 22 facing away from the combustion/mixing chamber 14 in the example being shown. It is, of course, also possible to position this heating means 34 between the bottom area 22 and the porous evaporator medium 24 in order to achieve an even more efficient introduction of heat into this porous evaporator medium. By energizing the heating means 34, the temperature can be consequently raised in the area of the porous evaporator medium 24, so that the evaporation of the fuel fed in via the line 26 will begin there with increased intensity. As was stated above, a mixture of air and fuel vapor, which is very greatly enriched with fuel, is formed now in the combustion/mixing chamber 14, and the operation is preferably carried out there such that a lean mixture in the range of λ(lambda)=2 becomes established.

However, the amount of heat introduced by the heating means 34 would not suffice to bring the entire system, especially the area of the system near the catalyst, to the necessary temperatures. The fuel-air mixture generated in the combustion/mixing chamber 14 is therefore ignited according to the present invention by energizing the igniting member 28 when starting up such an evaporator device 10 or a reformer for producing hydrogen. The igniting member 28 may be activated simultaneously with the energization of the heating means 34, but it may also be activated only when a sufficient amount of fuel vapor is present in the combustion/mixing chamber 14 after the heating means 34 had already been activated. Since the igniting member 28 is positioned in an area located close to the porous evaporator medium 24, it is active in an area in which a comparatively large percentage of fuel vapor will be present, so that the combustion will begin rapidly and will rapidly spread over the entire area of the combustion/mixing chamber 14 due to the air flowing in via the openings 16. The combustion flame and the hot combustion waste gases are also carried through the diaphragm 32 with the flow and thus they enter the volume area 30. They contribute there very effectively and rapidly to the heating of the system components located there and especially also to the heating of the catalyst material. It was found that the temperatures necessary for starting the catalytic reaction can be reached in about 15 to 30 sec in this manner.

If the necessary temperatures occur in the area of the system that is essential for the catalytic reaction, which can either be detected by a temperature sensor 36 or ensured by presetting a predetermined combustion time, the combustion is terminated. This may also be brought about by interrupting or reducing the fuel supply and/or the air supply into the combustion/mixing chamber 14 for a short period of time. After the combustion flame goes out, the fuel supply and the air supply are resumed, so that the hydrocarbon-air mixture to be reacted in the reformer will then continue to be produced in the combustion/mixing chamber 14 in the range of λ=0.4, and this mixture will reach the catalyst material in the unburned state. Since the catalyst material had been heated to the necessary temperature by the hot combustion waste gases before, the catalytic reaction starts producing hydrogen.

To achieve the most rapid possible spread of the combustion and consequently also the most rapid heating possible of the essential system areas, the heating means 34 may be operated in the above-described procedure according to the present invention until the combustion is terminated by the above-described procedures after the predetermined temperatures have been reached. It is, of course, also possible to shut off the heating means 34 to save electricity when the combustion has been started by energizing the glow-type igniting member 28. Very rapid spread of the combustion will occur in this case as well, because very high temperatures, which support the evaporation of initially still liquid fuel from the porous medium 24, are also present above all in the area of the combustion/mixing chamber 14 due to the combustion. After the termination of the combustion, the heating means 34 is preferably not put into operation any more in order not to excessively load the onboard power supply system in a vehicle. The heating of the mixture to be generated in the combustion/mixing chamber 14 can then be achieved during this phase, e.g., by obtaining heat from the processes taking place, e.g., in a fuel cell or from the processes taking place in the catalyst of the reformer, which heat will then be transferred to the housing 12 via a heat exchange fluid and corresponding heat exchanger devices. It is, of course, also possible to provide another heating means, e.g., a heating means that can be operated electrically, in the area of the housing 12 in order to maintain the catalytic reaction, e.g., at very low outside temperatures. In case of use in conjunction with an exhaust gas guiding system of an internal combustion engine, it is, of course, possible to allow the exhaust gases discharged by the internal combustion engine to flow around the housing 12 or to remove heat from these exhaust gases and to transfer it to the housing 12.

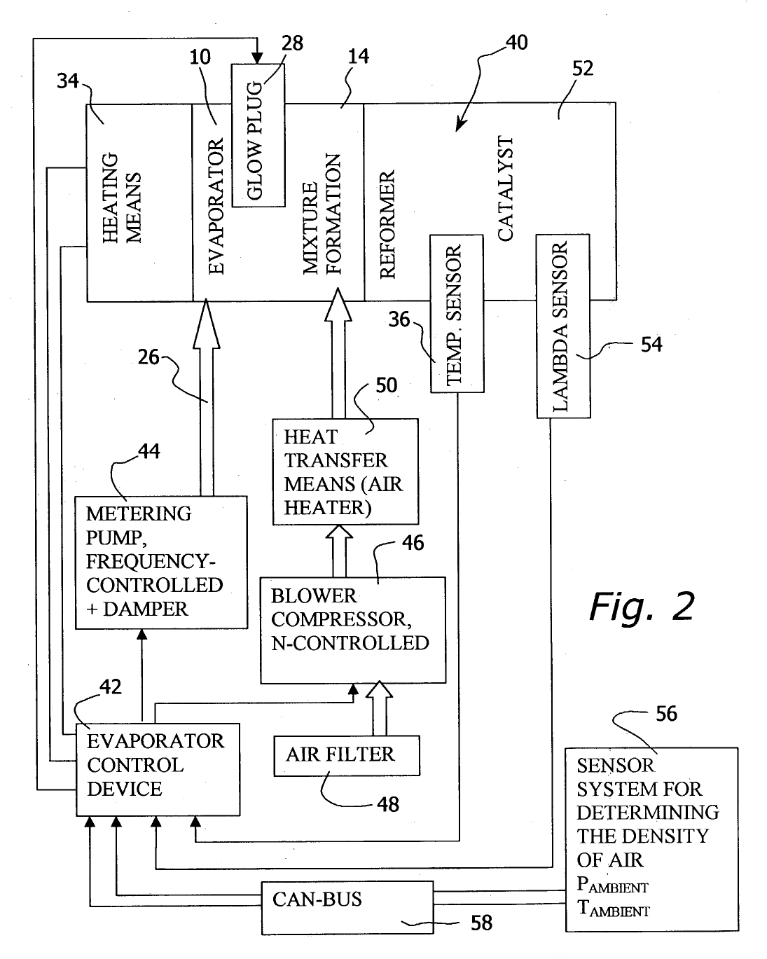

FIG. 2 shows a reformer system 40 in which the evaporator device 10 according to the present invention is used. The heating means 34, which is under the control of a control device 42, can also be recognized in the evaporator device 10 in FIG. 2. A metering pump 44, which is likewise under the control of the control device 42, feeds the fuel or hydrocarbon to be evaporated via the line 26 into the combustion/mixing chamber 14, and this feed may be carried out in a frequency-controlled, i.e., timed manner. A damper, i.e., an intermediate storage unit, from which the liquid being delivered will then be released in the direction of the combustion/mixing chamber 14 in a more or less continuous manner, may be associated with the metering pump 44. A blower 46, which is likewise under the control of the control device 42, takes up air via an air filter 48 and feeds same, optionally passing it through a heat exchanger 50 in a preheated manner, into the combustion/nixing chamber 14 for forming the mixture. Furthermore, the glow-type igniting plug 28, which ignites the fuel-air mixture formed in the combustion/mixing chamber 14 and acts as an igniting member, can be recognized. The reformer part 52 of the reformer system 40 with the catalyst material is located downstream of the combustion/mixing chamber 14. The temperature sensor 36 is also arranged in this area. Furthermore, a lambda sensor 54 may be provided, which is used, as was described above, to set the fuel-to-air ratio during different phases of the operation such that a desired lambda value will be obtained.

The various actuating measures performed by the control device 42 take place with the involvement of various parameters, e.g., the temperature detected by the temperature sensor 36, the initial value of the lambda sensor 54 as well as various other sensors, which supply data relevant for the operation of the system 40. This may also be, e.g., a sensor system 56 for correctly setting the mixture, by which the ambient pressure and the ambient temperature are detected, e.g., to determine the density of the air, and the data detected by this sensor system are sent into the control device 42 via a data bus system 58.

The system shown in FIG. 2 may then be operated for start-up, on the one hand, and for producing hydrogen, on the other hand, as was already described above with reference to FIG. 1.

The present invention provides an evaporator device and a process for starting same or a process for starting a reformer for producing hydrogen, which ensure with a comparatively simple design that the temperatures necessary for carrying out the catalytic reaction can be reached in a very short time, without having to excessively load the onboard electric power supply system. The present invention essentially takes advantage of the fact that the mixture proper that is to be decomposed in the reformer is combustible, so that even though a catalytic reaction is not carried out during a short time period of the start phase, the basic material actually used for producing hydrogen is burned in order to bring the reformer system to the necessary temperatures.

While specific embodiments of the invention have been shown and described in detail to illustrate the application of the principles of the invention, it will be understood that the invention may be embodied otherwise without departing from such principles.

What is claimed is:

1. An evaporator device for generating a hydrocarbon-air mixture which can be decomposed in a reformer for producing hydrogen, the evaporator device comprising:
a burner/evaporator area with a combustion/mixing chamber with air entering the combustion chamber via an inlet opening device;
a hydrocarbon evaporating means including a porous evaporator medium disposed in the burner/evaporator area;
a first heating means associated with said hydrocarbon evaporating means;
a glow-type igniting member for igniting a hydrocarbon-air mixture present in the combustion/mixing chamber.

2. An evaporator device in accordance with claim 1, wherein said hydrocarbon evaporating means is arranged in a bottom area of said combustion/mixing chamber.

3. An evaporator device in accordance with claim 1, wherein said inlet opening device is formed in a wall area surrounding said combustion/mixing chamber.

4. An evaporator device in accordance with claim 1, wherein said glow-type igniting member is elongated and extends at a spaced location from said hydrocarbon evaporating means approximately in parallel to same.

5. An evaporator device in accordance with claim 1, wherein said first heating means is operated electrically.

6. An evaporator device in accordance with claim 1, further comprising a second heating means for heating a wall surrounding said combustion/mixing chamber and/or a wall adjoining said combustion/mixing chamber in a direction of flow.

7. An evaporator device in accordance with claim 6, wherein the second heating means comprises a heat exchanger device through which heated fluid can flow.

8. A process for starting an evaporator device with a burner/evaporator area with a combustion/mixing chamber with air entering the combustion chamber via an inlet opening device, a hydrocarbon evaporator including a porous evaporator medium disposed in the burner/evaporator area, and a glow-type igniting member for igniting a hydrocarbon-air mixture present in the combustion/mixing chamber, the evaporator for generating a hydrocarbon-air mixture which can be decomposed in a reformer for producing hydrogen, the process comprising the steps:
a) heating and evaporating liquid hydrocarbon or hydrocarbon-containing liquid;
b) mixing of the vapor generated in step a) with air;
c) igniting of the mixture generated in step b) to start the combustion of the mixture;
d) maintaining the combustion until the expiration of a predetermined time period and/or until a predetermined temperature is present in one or more predetermined areas of the system; and
e) terminating the combustion after the expiration of the predetermined time period and/or after the predetermined temperature has been reached.

9. A process in accordance with claim 8, wherein a heater may be operated electrically for the evaporation.

10. A process in accordance with claim 9, wherein said heater remains activated at least during the steps c) and d).

11. A process in accordance with claim 8, wherein the supply of liquid hydrocarbon or of the hydrocarbon-containing mixture is reduced or interrupted and/or the supply of air is reduced or interrupted in step e).

12. A process in accordance with claim 11, wherein the supply of liquid hydrocarbon or of the hydrocarbon-containing liquid and the supply of air for generating the mixture which can be decomposed for producing hydrogen are continued or maintained after the termination of the combustion in step e).

13. A process in accordance with claim 8, wherein a heater is activated at least until the combustion is generated and then is not activated in and/or after step e).

14. A process in accordance with claim 8, wherein a fossil fuel including one of diesel fuel, kerosene, gasoline or synthetic or mixed hydrocarbon is used as the liquid hydrocarbon or hydrocarbon-containing liquid.

15. A reformer for producing hydrogen from a hydrocarbon-air mixture, comprising:
an evaporator with a burner/evaporator area with a combustion/mixing chamber with air entering the combustion chamber via an inlet opening device, a hydrocarbon evaporating means including a porous evaporator medium disposed in the burner/evaporator area, a first heating means associated with said hydrocarbon evaporating means and a glow-type igniting member for igniting a hydrocarbon-air mixture present in the combustion/mixing chamber.

16. A reformer according to claim 15, further comprising:
a reformer part with a catalyst element;
a temperature sensor arranged for sensing the temperature in an area of the reformer part;
a lambda sensor to set the fuel-to-air ratio during different phases of the operation such that a desired lambda value will be obtained; and
a control device for receiving signals relating to the temperature detected by the temperature sensor and an initial value of the lambda sensor and controlling said evaporator.
